(19) United States
(12) Patent Application Publication
(10) Pub. No.: US 2018/0108982 A1
(43) Pub. Date: Apr. 19, 2018

(54) Sensor Device for a Vehicle, Motor Vehicle

(71) Applicant: Robert Bosch GmbH, Stuttgart (DE)

(72) Inventors: Daniel Schoenfeld, Abstatt (DE); Michael Roelleke, Leonberg-Hoefingen (DE)

(21) Appl. No.: 15/782,393

(22) Filed: Oct. 12, 2017

(30) Foreign Application Priority Data
Oct. 14, 2016 (DE) 10 2016 220 036.4

(51) Int. Cl. H01Q 1/32; H01Q 21/06; B60Q 3/80; B60R 16/03

(52) U.S. Cl. CPC H01Q 1/3283; H01Q 21/061; B29L 2031/752; B60R 16/0315; B60Q 3/80

(57) ABSTRACT

A sensor device for a vehicle at least one sensor module and at least one connecting line. The sensor module includes at least one sensor. The connecting line is connected to the sensor module and configured to electrically contact the sensor module. The at least one connecting line is configured as a conductor foil. The at least one sensor module is disposed on the conductor foil and is encapsulated by an overmold. The overmold at least partially envelops the conductor foil. The conductor foil includes a two-wire line configured to contact the at least one sensor according to a peripheral sensor interface.

This application claims priority under 35 U.S.C. § 119 to patent application no. DE 10 2016 220 036.4, filed on Oct. 14, 2016 in Germany, the disclosure of which is incorporated herein by reference in its entirety.

### BACKGROUND

The present disclosure relates to a sensor device for a vehicle, in particular a motor vehicle, having at least one sensor module, and having at least one connecting line, connected to the sensor module, for electrically contacting the sensor module. The disclosure additionally relates to a body component part for a vehicle having such a sensor device. Furthermore, the disclosure relates to a method for producing a corresponding sensor device or a corresponding body component part.

Sensor devices of the type stated at the outset are known from the prior art. In order to increase safety for passengers and other road users, it is known to provide on the vehicle safety means that, in particular in the case of an accident, protect the passengers and/or other road users such as, for example, pedestrians, against injury. In particular, airbag means, seatbelt tensioners and the like are known as a safety means. The safety means in this case are controlled in dependence on sensor data of sensor devices that sense a collision, for example with the other road user, in particular a pedestrian. Systems having two or more acceleration sensors and/or comprising a pressure hose based system are known for detecting pedestrian accidents. These systems are then disposed, for example, in a bumper of the vehicle, in order to sense the collision of the vehicle with an object from the environment. At present, for the purpose of sensing collisions on a longitudinal side of a vehicle, sensor devices are used that are disposed on the B, C or D column of the vehicle, in particular having at least one acceleration sensor, or in the vehicle door, in particular having at least one acceleration sensor. For the purpose of identifying collisions with objects in the front region, at present acceleration sensors are used that are located, for example, in the central control device and/or along a flexible crossmember of the vehicle. The signals output by the sensors are further processed by algorithms of a control device, in particular an airbag control device, in order to decide about the triggering of the respective safety means of the vehicle.

Usually, the sensors are fastened, as a sensor module having its own housing and a connecting line for electrical contacting, to a body part of the vehicle such as, for example, to the bumper or a door panel. Frequently, a screwed or clip connection is provided for fastening. The electrical contacting is often also effected via a plug connector mounted on a wiring harness. For electrical contacting of electronic components it is also known, in principle, to use a conductor foil that carries one or more electrical conductor paths on at least one carrier foil, or between at least two carrier foils, and that is realized so as to be flexible. Owing to the in particular flat structure of the conductor foil, the latter can be integrated into existing structures in a manner that saves structural space.

### SUMMARY

The sensor device according to the disclosure has the advantage of providing a compact and easily handled sensor device that, advantageously, can be integrated into the vehicle and facilitates positioning and control of a plurality of sensor modules. For this purpose, it is provided according to the disclosure that a plurality of like sensor modules, i.e. sensor modules having at least the same sensors, are disposed on the connecting line realized as a conductor foil and are each encapsulated by an overmold that at least portionally envelops the conductor foil, and that the conductor foil has a two-wire line for contacting the sensors by means of a peripheral sensor interface 5 (PSI5). Owing to the overmold on the conductor foil, the sensor modules are thus held on the conductor foil in a simple manner. In particular, the distances between adjacent sensor modules are already fixed prior to mounting, with the result that the actual mounting can be performed in a rapid but still precise manner. Each sensor module is electrically connected to at least one electrical conductor path of the flexible conductor foil. This may be effected, for example, during production, by soldering or physical contacting. In particular, the conductor foil has contacting portions, in which the one conductor path or the plurality of conductor paths has/have a widened or enlarged contacting surface area in comparison with the rest of the course of the conductor paths through the conductor foil, such that easy electrical contacting of the sensor module is ensured at this point. Such sensor devices may preferably be disposed in the vehicle door, but may also be disposed, for example, in a bumper or in one of the vertical columns of the vehicle. Preferably, on one side the conductor foil has an adhesive, by means of which the conductor foil can easily be fastened, or at least pre-mounted, on a body element, for example on a panel element. The conductor foil is thus preferably of a multilayer structure and, in particular, has an adhesive layer that is preferably covered by a removable protective layer prior to mounting. Owing to the two-wire line of the conductor foil and the contacting of the sensors by means of a peripheral sensor interface 5 according to the PSI5 protocol, it is possible for the sensors to be operated in parallel by means of a BUS system, with the result that the sensor device provides an improved performance due to the simultaneous signal transmission and evaluation, such that two independent measurement values of the two sensors of the sensor modules are available at a measuring point, which values can be checked against each other for plausibility. In particular, the sensors of the sensor modules are realized as acceleration sensors. Besides a parallel BUS mode, however, it is also conceivable, if necessary, to control the sensors by a universal BUS mode or a daisy-chain BUS mode.

Preferably, however, the sensors are connected in parallel by means of the two-wire line and the sensor interface 5, with the aforementioned advantage.

Furthermore, it is preferably provided that the respective overmold has at least one fastening means for fastening the sensor module to a body part of the vehicle. The fastening means may be, for example, a latching means or a clamping means, which acts in combination with a corresponding counter-means of the body part of the vehicle in order to fasten the sensor module, in particular detachably, to the body part. The overmold is realized, for example, in such a manner that the housing formed by the overmold has plug-in receptacles and/or plug-in projections that act in combination with corresponding plug-in projections and plug-in receptacles, respectively, of the body part, for the purpose of fastening the sensor module. In particular, the fastening means are realized so as to be elastically deformable, at least in regions, to enable the sensor module to be latched or clipped-in on the body part. Furthermore, it is preferably provided that the overmold concomitantly constitutes the body part, at least partly. The sensor device is therefore an integral constituent part of the body part, and is already concomitantly taken into account in the production of the body part. As a result, although exchange of the sensor device itself is rendered more difficult, production of the body part with the sensor function is facilitated.

According to a preferred development of the disclosure, it is provided that only two like sensor modules, as previously described, are disposed on the conductor foil. As a result, parallel operation is reliably ensured, and the sensor device is of a simple and inexpensive design.

Preferably, the overmold is realized so as to be elastically deformable. This ensures that the respective sensor module as a whole is elastically deformable, so as to enable the sensor module to be subsequently formed onto a body part. It is thereby ensured that the sensor module, or the sensor device, can be mounted easily and with a precise fit.

Expediently, the respective sensor module has a carrier, on which, respectively, an acceleration sensor is disposed. This carrier is realized, in particular, as a so-called interposer, having electrical conductor paths that lead to a separating of electrical contacts. Thus, first ends of the conductor paths that are assigned to the acceleration sensor are disposed more closely in relation to each other than are the other ends of the conductor paths that contact conductor paths of the conductor foil. This ensures secure contacting of the acceleration sensor, and at the same time in a simple manner prevents an unwanted short circuit, in particular in the region of contacting to the conductor foil. Preferably, the acceleration sensor, for pre-mounting, is already mounted on the carrier. The acceleration sensor in this case can be mounted on the carrier in a conventional manner. Alternatively, it is provided that the acceleration sensor, and optionally associated electrical/electronic components, are disposed directly on the conductor foil and electrically connected to the latter.

Furthermore, it is preferably provided that the carrier is realized so as to be flexible. It is thereby reliably ensured, in particular, that the shape of the respective sensor module itself can be adapted to a body part, for example having a curvature, as is usual, for example, in the case of bumpers. In particular, the electronic/electrical components of the acceleration sensor are preferably likewise realized so as to be deformable without damage. In particular, for this purpose, for example, integrated circuits are realized so as to be sufficiently thin in order to be elastically deformable.

According to a preferred development of the disclosure, it is provided that the conductor foil is realized in the form of a strip, and has at least one elastically and/or plastically deformable carrier foil and at least one conductor path that is elastically and/or plastically deformable concomitantly with the carrier foil. The conductor foil thus extends in the form of a strip, or in the form of a band, and is provided with sensor modules along its course, as previously described. The elastically and/or plastically deformable carrier foil(s) and conductor path(s) enable the conductor foil to be easily inserted and adapted to the respective body part.

The body component part according to the disclosure, having the features further disclosed herein, is characterized by a body part and at least one sensor device fastened to the body part and realized according to the disclosure. The advantages already mentioned ensue in this case.

In particular, it is provided that the sensor device is realized so as to be integrated into the body component part. Preferably, for this purpose, the body component part is realized, at least portionally, as overmolding of the sensor device. In particular, the body component part constitutes an additional encapsulation, or the previously mentioned encapsulation, for the respective sensor module of the sensor device.

The method according to the disclosure for producing the sensor device as described above, or for producing the body component part described above, is characterized by the features further disclosed herein. It is provided in that case that, firstly, the same sensor modules are disposed on the connecting line, realized as a conductor foil, and that the conductor foil and the respective sensor module are then overmolded in such a manner that the respective sensor module is encapsulated by an overmold that also at least portionally envelops the conductor foil. The advantages already mentioned ensue in this case.

Further advantages and preferred features and feature combinations are disclosed, in particular, by the preceding description and by the claims.

### BRIEF DESCRIPTION OF THE DRAWINGS

The disclosure is to be explained in greater detail in the following on the basis of the drawing. For this purpose, there are shown:

FIG. 1 a sensor device, in a simplified sectional representation,

FIG. 2 a sensor module of the sensor device, in a simplified top view, and

FIG. 3 a body component part of a motor vehicle, in a simplified representation.

### DETAILED DESCRIPTION

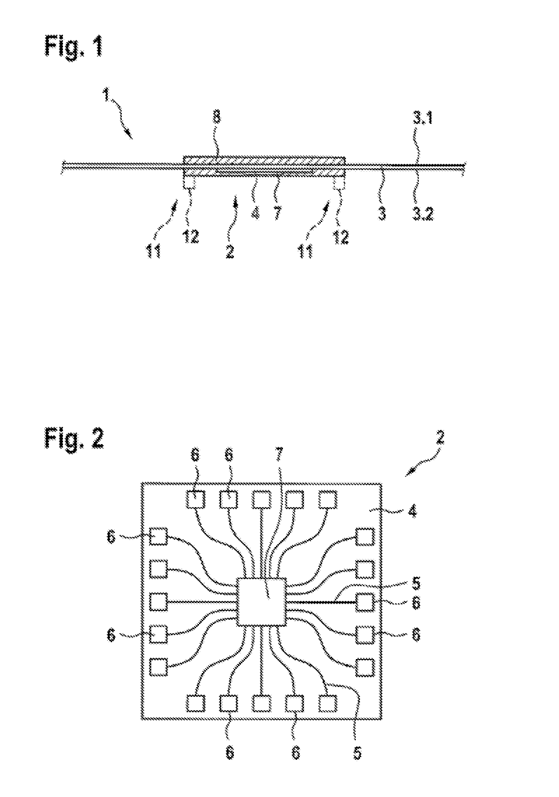

FIG. 1 shows, in a simplified longitudinal sectional representation, a sensor device 1, which has a sensor module 2 and a flexible conductor foil 3. The conductor foil 3 is realized in the form of a strip or band, and is composed, in particular, of at least one carrier foil 3_1, disposed on which there are two electrically conductive conductor paths 3_2. The conductor foil 3 is produced, in particular, in a known manner.

FIG. 2 shows the sensor module 2 in a simplified top view. The sensor module 2 has a carrier 4, which is made of an electrically non-conductive and elastically deformable material. Disposed on the carrier 4 are a plurality of conductor paths 5, which extend in the form of a star from the outside inward, or vice versa. Disposed at each of the outer edges of the carrier 4 are a plurality of electrically conductive contact points 6, only some conductor paths 5 and contact points 6 being shown here for reasons of clarity. The contact points 6 are connected to respectively one end of one of the conductor paths 5, for example realized so as to be integral with the latter. The conductor paths 5 lead out from the contact points 6 into the center of the carrier 4, where an acceleration sensor 7 is disposed and electrically contacted by the free ends of the conductor paths 5. For the purpose of contacting the acceleration sensor 7, corresponding contact points are provided at the other ends of the conductor path 5, which are not visible in FIG. 2. The carrier 4, together with the conductor paths 5 and the respective contact points 6, thus form a so-called interposer, which provides a separating of the electrical contacts of the acceleration sensor 7 to the contact points 6, which, as compared with the contact points of the acceleration sensor 7, are disposed farther apart, and can therefore be contacted more easily. In this case, the contact points 6 are electrically connected to the conductor paths 3_2 of the conductor foil 3.

The carrier 4 is applied on the conductor foil 3 in such a manner that the contact points 6 are in physical contact with the corresponding conductor paths 3_2 of the conductor foil 3, in order to produce an electrical connection. Optionally, the contact points 6 are welded or soldered to the respective conductor paths 3_2, in order to ensure permanence of the electrical contact. As an alternative to the exemplary embodiment represented, it is provided according to a further exemplary embodiment—not represented here—that the acceleration sensor 7 is disposed directly on the conductor foil 3 and electrically is electrically connected to the corresponding conductor paths 3_2 of the conductor foil 3. Owing to the subsequent encapsulation by means of the overmold 8, the acceleration sensor 7 is held on the flexible conductor foil 3 in a sufficiently fixed and protected manner.

The sensor module 2 contiguous to the conductor foil 3 is encapsulated by an overmold 8 that also portionally envelops the conductor foil 3. Consequently, owing to the overmold 8, on the one hand the sensor module 2 itself is encapsulated and protected against external influences, and on the other hand the sensor module 2 is thereby fastened to the conductor foil 3 in a simple manner. To that extent, the sensor module 2 and the conductor foil 3 form an advantageous unit, allowing the sensor device 1 to be disposed on and fastened to a body part in a simple manner. According to the present exemplary embodiment, two such sensor modules 2_1 and 2_2, as described in relation to the sensor module 2, are disposed on the conductor foil 3, and connected to the conductor foil 3 by a respective overmold 8. By means of the conductor foil 3, the sensor device 1 is connected, in particular, to a control device, not represented here, that, the sensor data sensed or provided by the acceleration sensor 7, controls a safety means of a vehicle, such as, for example, an airbag means or a seatbelt tensioner.

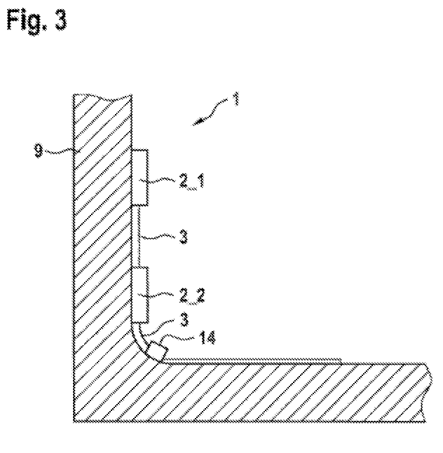

For the purpose of disposition in the vehicle, the sensor device 1 is easily fastened to a body part. For this, FIG. 3 shows, in an exemplary embodiment, a body part 9 of a motor vehicle, in a sectional representation, the body part 9 being constituted by a B column of the motor vehicle. The body part 9 is at least portionally curved, and disposed on the inner side thereof is the sensor device 1, which, in the present exemplary embodiment, has the two sensor modules 2_1, 2_2, which are disposed on the conductor foil 3, as previously described. Since the sensor modules 2_1, 2_2 are each encapsulated, together with the conductor foil 3, by the overmold 8, their distance in relation to each other on the conductor foil 3 is predefined, which simplifies mounting of the sensor device 1, with a plurality of sensor modules 2, on the body part 9. Owing to the flexible design of the conductor foil 3, the latter can easily be routed along the inner side 10 of the curved body part 9, such that it is disposed, or can be disposed, in a space-saving and optimal manner on the body part 9.

According to a further exemplary embodiment, which is likewise shown in FIG. 3, the sensor device 1 is realized so as to be integrated in the body part 9. In this case, the body part 9 is, in particular, a panel element such as, for example, a door element or a panel element of the B column. For this purpose, the body part 9 itself constitutes a part of the overmold 8 of the sensor module 2_2, which is shown exemplarily in FIG. 3. The body part 9 can thus be directly formed concomitantly with the overmold 8, such that a particularly compact and easily handled unit is produced. It is also conceivable that the respective sensor module 2_2 is subsequently enveloped by an additional overmold 8 of the body part 9 and is thereby held on the latter. Preferably, both sensor modules 2_1, 2_2 are fastened to the body part 9 according to the further exemplary embodiment. Clearly, more than two sensor modules 2 may also be disposed on the conductor foil 3. The body part 9, together with the sensor device 1, thus constitutes an advantageous body component part that is already provided with an acceleration sensor system for controlling safety means of the motor vehicle.

Disposed at a free end of the conductor foil 3 there is a connector plug 14 that is likewise produced by overmolding of the conductor foil 3. The connector plug 14 provides the connection to the already previously mentioned control device, in particular airbag control device, of the vehicle. By means of the plug 14, the sensor device 1 can be connected, in particular, to a peripheral sensor interface 5, which is constituted by a digital interface according to the PSI5 protocol for sensors. The sensor interface 5 in this case is based on the two-wire line, and is already used in automobile electronics for connecting external sensors to electronic control devices. The interface in this case supports point-to-point and BUS configurations with asynchronous and synchronous communication. In the present case, it is provided that the sensor device is operated by a parallel BUS configuration, such that the two acceleration sensors 7 can be operated in parallel with each other. By this means, two measurement data, which can be checked against each other for plausibility, are obtained simultaneously.

Owing to the flexibility of the sensor device 1, the sensor modules 2_1 and 2_2 may be disposed over one another, as represented in FIG. 3, or if necessary may also be disposed next to one another, on the body part 9.

The integration of the sensor device 1 into the body part 9 offers the advantage of a concealed mounting, which prevents the end user from interfering with the electronic system. The system safety is thereby increased. Owing to the small thickness of the sensor device 1, the mechanical structural integrity of the body part 9 is not affected, or is scarcely affected, by the integration of the sensor device 1 into the body part 9. The sensor function of the sensor device 1, as an integral stand part of the body part 9, can be combined with other functions directly integrated in the end component part, such as, for example, an integrated electrical energy storage device, heating wires or induction coils, thereby realizing multifunctionality of the body component part as a conductive design.

In particular, owing to the integrated design of the sensor device 1, high precision is achieved in the positioning and orientation of the sensor on the conductor foil, or on the body part 9, with the result that the number of steps in production and in a subsequent testing of the functional capability can be reduced.

The production of the sensor device 1 by foil-based back-molding technology or overmolding technology, or alternatively by a foil-based integration into the body part 9, is inexpensive and not very time-consuming. For the purpose of mounting the sensor device 1, it may also be provided that the overmold 8 in each case has one or more fastening means 11, which bear against the body part 9 for the purpose of fastening the respective sensor module 2. It is thus provided, according to the exemplary embodiment represented by broken lines in FIG. 1, that the fastening means 11 are realized as plug-in projections 12, which can be plugged into corresponding plug-in receptacles 13 of the body part 9. Expediently, the plug-in projections 12 and plug-in receptacles 13 are realized to form an interference fit in each case, such that the respective sensor module 2 can be easily mounted, or at least pre-mounted, on the body part 9. It is also conceivable to realize the fastening means as latching means, to enable the respective sensor module 2 to be latched in a form-fitting manner to the body part 9.

Moreover, in this case the production costs can be further reduced in that a 2R2 production line is used, or in that open semiconductors are mounted directly, with the aim of reducing foil surface area. The production costs are also reduced as a result of the ease of mounting of the sensor device 1 on the vehicle, or on the body part 9, for example by direct integration of the sensor device 1 into the body part 9 as a fiber-reinforced plastic structure in the case of a molding process, in particular in the case of an LCM process (LCM=liquid composite molding).

Owing to the technique used, the acceleration sensors 7 of the sensor modules 2 are easily directly integrated into the body part 9, in particular into the B column, or disposed on the latter. Clearly, the body part 9 may also be a door panel or, for example, a bumper of the motor vehicle. It is also conceivable to dispose the sensor device 1 in a vehicle seat. By use of direct plug-in techniques, simple electrical connections of the component parts of the sensor device 1 can be realized. Moreover, owing to the advantageous encapsulation of the sensor modules 2, a customer-specific plug connector can be directly attached to the conductor foil 3. Owing to the flexible design of the sensor device 1, subsequent deformation of the sensor device 1, as already shown in the example of FIG. 3, is also possible. By use of a suitable fall technique, complex structures and geometries can be produced, to the extent of stacking a plurality of sensor modules over one another. If the conductor foil 3 has more than 2 layers of carrier foil and conductor paths, it is also possible to realize complex electrical circuits by means of a multilayer structure. Preferably, the carrier material of the conductor foil 3, and optionally also the carrier 4 of the respective sensor module 2, are made of an elastically and plastically deformable material, such that the carrier foil 3, and if necessary the carrier 4, can be extended or stretched and deformed in all directions. In particular, owing to the deformability of the carrier 4, it is possible to realize the sensor module 2 itself as an adapted insert component, such that it fits into a three-dimensionally shaped body part, or can be positioned on the latter, with shape precision.

What is claimed is:

1. A sensor device for a vehicle, comprising:
at least one sensor module including at least one sensor; and
at least one connecting line connected to the at least one sensor module and configured to electrically contact the at least one sensor module, the at least one connecting line configured as a conductor foil on which the at least one sensor module is disposed,
wherein the at least one sensor module is encapsulated by an overmold that at least portionally envelops the conductor foil, and
wherein the conductor foil includes a two-wire line configured to contact the at least one sensor according to a peripheral sensor interface.

2. The sensor device according to claim 1, wherein sensors of the at least one sensor module are connected in parallel via the two-wire line and the peripheral sensor interface.

3. The sensor device according to claim 1, wherein the overmold includes at least one fastening member configured to fasten the at least one sensor module to a body part of the vehicle.

4. The sensor device according to claim 1, wherein the at least one sensor module includes exactly two sensor modules disposed on the conductor foil.

5. The sensor device according to claim 1, wherein the overmold is elastically deformable.

6. The sensor device according to claim 1, wherein the at least one sensor module further includes a carrier on which an acceleration sensor is disposed.

7. The sensor device according to claim 6, wherein the carrier is flexible.

8. The sensor device according to claim 1, wherein:
the conductor foil is configured as a strip form and further includes at least one elastically and/or plastically deformable carrier foil; and
the two-wire line is elastically and/or plastically deformable concomitantly with the carrier foil.

9. A body component part for a vehicle, comprising:
a body part, and
at least one sensor device fastened to the body part, and including:
at least one sensor module including at least one sensor; and
at least one connecting line connected to the at least one sensor module and configured to electrically contact the at least one sensor module, the at least one connecting line configured as a conductor foil on which the at least one sensor module is disposed,
wherein the at least one sensor module is encapsulated by an overmold that at least portionally envelops the conductor foil, and
wherein the conductor foil includes a two-wire line configured to contact the at least one sensor according to a peripheral sensor interface.

10. A method for producing a sensor device for a vehicle, the sensor device including at least one sensor module including at least one sensor, and at least one connecting line configured as a conductor foil, the method comprising:
connecting the conductor foil to the at least one sensor module such that the conductor foil electrically contacts the at least one sensor module;
disposing the at least one sensor module on the conductor foil, the at least one conductor foil including a two-wire line configured to contact the at least one sensor according to a peripheral sensor interface; and
encapsulating the at least one sensor module with an overmold and at least portionally enveloping the conductor foil with the overmold.

11. The sensor device according to claim 1, wherein the vehicle is a motor vehicle.

12. The body component according to claim 9, wherein the vehicle is a motor vehicle.
